(19) United States
(12) Patent Application Publication
(10) Pub. No.: US 2007/0251912 A1
(43) Pub. Date: Nov. 1, 2007

(54) Closure System With Thermochromic Tamper-Control Means

(75) Inventors: Pierre Sixou, Nice (FR); Herve Guillard, Talence (FR); Hanno Kaess, Esslingen (DE)

Correspondence Address: Ralph A. Dowell of DOWELL & DOWELL P.C., 2111 Eisenhower Ave, Suite 406, Alexandria, VA, 22314, US

(73) Assignee: TETRA LAVAL HOLDINGS & FINANCE S.A., CH - Pully (CH)

(21) Appl. No.: 10/582,871

(22) PCT Filed: Dec. 22, 2004
(86) PCT No.: PCT/FR04/03346

§ 371 Date: May 11, 2007

(30) Foreign Application Priority Data
Dec. 22, 2003 (FR) 0315169

(51) Int. Cl. G01K 11/00; B65D 79/02

(52) U.S. Cl. 215/263; 264/239

(57) ABSTRACT

The present invention relates to a closure system including a thermochromic tamper-control means of color that is irreversibly modified in the event of the temperature of the closure system being raised above a threshold temperature, said closure system comprising a polymer matrix having incorporated therein at least one thermochromic pigment of color that is irreversibly modified after said closure system has been exposed to a temperature close to or above a threshold temperature. The invention also relates to a method of preparing a thermochromic closure system, and to receptacles provided with said system.

### FIELD OF THE INVENTION

The invention relates to a closure system provided with a tamper-control means, the color of which is irreversibly modified when the temperature of the closure system increases beyond a threshold temperature. The invention also relates to a method of fabricating said closure system. Further, the invention relates to a method of checking for tampering of a closure system using heat, and to receptacles provided with said closure system.

### DESCRIPTION OF THE PRIOR ART

In order to protect the contents of receptacles, e.g. of the bottle type and containing water or any other liquid, against attempts to incorporate foreign bodies or to substitute their contents, protective systems have been used for a number of years and are already widely used on an industrial scale. The most usual systems in use are characterized by a closure system having a tamper-proof collar connected to the closure by bridging tabs. Unscrewing the closure inevitably causes definitive rupture of the bridging tabs, providing proof that the bottle has been opened.

However, it appears to be possible to remove the closure system in its entirety (closure plus collar) by heating it to the softening temperature of the plastic material constituting the closure system, without breaking the bridging tabs, then to replace the whole closure system on the receptacle. On cooling, the closure system regains its position and function without suffering visible damage. Thus, the closure system of the receptacle can be tampered with out leaving any traces. The protection conferred by such protective systems is thus not total.

Furthermore, the literature provides examples of protective systems which can provide evidence of tampering or an attempt at tampering by raising the temperature. Such protective systems are essentially of three types.

The first type concerns multi-layered films, usually integrated into labels which, if an attempt is made to remove them by heating the adhesive, are designed so that irreversible delamination of certain layers occurs as described, for example, in United States patents U.S. Pat. No. 5,683,774 and U.S. Pat. No. 5,510,171. Such multi-layered films may also be bonded to the neck of a bottle and contain a thermochromic layer such as that described in U.S. Pat. No. 4,733,786.

It may also be an opaque film which becomes transparent in an irreversible manner when heated beyond a certain temperature, such as that described in U.S. Pat. No. 5,660,925 and U.S. Pat. No. 4,407,443.

Finally, a thermochromic material may be incorporated into a label type protective system, for example, usually as a component of an ink, as described in United States patents US-A-2001/0022280, U.S. Pat. No. 5,407,277, British patents GB 2 374 583, GB 2 334 092 and European patent EP-A-0 837 011.

US-2003/0127416 describes a closure which changes color irreversibly or otherwise in the temperature range −25° C. to 85° C. The thermochromic compound is in contact with the plastic material or may be mixed into the plastic material. In the case of incorporation of the thermochrome into the thermoplastic, no reference is made to any need for deactivation of the thermochrome during the stage of incorporation into the thermoplastic material in order to avoid the appearance of an unwanted color during production of the closure.

However, that document makes no reference to the principle of irreversible color change as a protection means. It is hinted that the color change (indicated as being preferably reversible) produces an effect which is commercially attractive. Further, only a few thermochromic substances are mentioned and they are not suitable for the present invention since they are not inactive during all of the steps for manufacturing the closure system.

International patent WO-A-87/06692 and its corresponding United States patent U.S. Pat. No. 5,085,801 discloses a temperature indicator using a thermochromic compound which irreversibly changes color with temperature. That compound is incorporated into a thermoplastic plastic and the ensemble is made into a thermoplastic film. The aim of those thermochromic thermoplastic films is to ensure that frozen or deep frozen perishable goods (food, pharmaceuticals, or other goods placed in packaging comprising said film) has not been subjected to a temperature rise up to its defrosting point.

The above prior art neither discloses nor suggests the use of a thermochromic compound as an indicator of tampering by exposure to heat, in particular by exposure to a temperature corresponding to the softening temperature of the thermoplastic material. Further, only its use in films is envisaged, and nothing in that document suggests incorporating a thermochromic compound into thermoplastic matrices intended to be molded.

U.S. Pat. No. 6,607,744, US-2003/0143188, US-2003/0103905 and WO-A-02/00920 disclose foods or packaging materials in contact with foods, the color of which may be modified under the action of an external parameter such as temperature. Incorporating the thermochrome into the packaging material is also proposed and all of the examples relate to incorporating the thermochrome into or onto the food or the packaging material, which material must be in contact with the food, such that a color change of the packaging indicates that the food has been heated to an unsuitable temperature.

That problem is completely different to that of the present invention where food-closure contact is not at all necessary: one of the aims of the present invention is to provide a means for checking the temperature to which the closure is raised and not the temperature to which the contents are raised.

A further major difference resides in the fact that the color change described in the prior art is only superficial, while in the present invention, the color change occurs in the bulk of the closure system. There is no suggestion or indication as to the nature of the packaging material, nor the method of incorporating the thermochromic element into said packaging material.

The prior art makes no reference to incorporating a thermochromic pigment as a tamper indicator into a closure system. Checking for tampering by raising the temperature to the softening temperature of said closure system has not until now been mentioned or suggested in the prior art.

Thus, in a first aspect, the present invention consists in providing a closure system comprising a visual means for checking for tampering or an attempt at tampering caused by raising the temperature of said closure system beyond a threshold temperature.

In a further aspect, the present invention consists in providing a closure system comprising firstly, at least one mechanical tamper-control means and secondly, a means for visually checking for tampering or an attempt at tampering caused by raising the temperature of said closure system, said visual checking means being realized by an irreversible color change of said closure system beyond a threshold temperature, corresponding to the minimum theoretical temperature at which tampering may be carried out without affecting the mechanical tamper proofing means.

These aims and others disclosed below are completely or partially achieved by the present invention, described in detail below.

Thus, in a first aspect, the present invention provides a closure system with a thermochromic control means which can provide evidence that said closure system, essentially formed from thermoplastic material, has been heated to an unusual temperature and thus has been tampered with or an attempt at tampering has been made.

Thus, the invention provides a closure system for a bottle or any other receptacle with a thermochromic tamper-control means the color of which is capable of being irreversibly modified when the temperature of at least a part of the closure system is raised to a value close to or beyond a threshold temperature.

The irreversible change in the color of the closure system essentially constituted by a thermoplastic material after exposing at least a part of said closure system to a temperature close to or beyond a thickness value is achieved by incorporating at least one thermochromic material in said thermoplastic material.

The term “close to or beyond a threshold temperature” means that all or several parts of the closure system is/are exposed to a temperature which is at least equal to the temperature at which the thermochromic material undergoes chemical and/or physicochemical transformations, producing a change in or the appearance of the color of said thermochromic material (“color change” or “threshold” temperature in the remainder of the description).

For a given thermochromic material, this color change temperature may depend, on its immediate environment, such as the nature of the polymer matrix, the presence of fillers, other thermochromic materials, etc.

The change in color of a thermochromic material may be due to several phenomena, such as:

decomposition of a compound, such as a colorant which loses its color when heated above its decomposition temperature as described, for example, in U.S. Pat. No. 4,756,758;

a reaction between several compounds involving an oxidizing organic silver salt and a reducer for the salt, as described in U.S. Pat. No. 6,113,857, or an electron-donating chromogenic material and an electron-accepting polymer resin, as described in U.S. Pat. No. 5,340,537, a reaction in which one of the reagents before reaction is colored or forms a compound which is itself colored;

a change in the state of the compound: fusion of an acetylenic compound may render it active to a temperature rise, which allows the color to fix, as described in US-A-2003/0103905, US-A-2003/0143188, WO-A-02/00920, US-A-2001/10046451, U.S. Pat. No. 6,607,744, U.S. Pat. No. 5,918,981, U.S. Pat. No. 5,731,112, U.S. Pat. No. 5,481,002, U.S. Pat. No. 5,085,801, WO-A-87/06692, U.S. Pat. No. 4,228,126, or a suitable heat treatment may cause a cholesteric liquid crystal the color of which depends on temperature to irreversibly retain a certain color, as described in U.S. Pat. No. 4,859,360; or

starting from one or more compounds, the generation of molecules which will react on another compound responsible for the color (chromogenic compound) thus inducing the irreversible color change, as described in U.S. Pat. No. 5,667,943 and U.S. Pat. No. 5,401,619: a phenol-formaldehyde resin may then cross-link. When it is heated, the molecule of water lost by condensation will interact with a chemichromic colorant and thus modify the color, as described, for example, in U.S. Pat. No. 5,990,199.

In the present invention, the thermochromic material (or “thermochromic pigment” or, more simply, the “thermochrome”, as used in the remainder of the present description) is incorporated into the thermoplastic matrix. This incorporation step is carried out at a temperature which is much higher than the color change temperature of the thermochrome; it must therefore be inactive during all of the steps of producing the closure system so that no color change occurs during production of the closure system. It must then be rendered active during a subsequent step.

A thermochromic material, initially inactive as regards temperature, is then incorporated into the thermoplastic matrix which forms a constituent of the closure system. After producing the closure system, the thermochromic compound is rendered active as regards a temperature rise. An irreversible change in color of the closure system can provide evidence of any attempt at tampering by raising the temperature of the closure system to be able to remove it and replace it without leaving a trace.

The color of an article is not only associated with the article itself, but also with the trio: light source, article and observer. Colorimetry defines standard illuminants and standard observers as well as certain representations that can quantify the notion of color, such as the CIE 1931 or CIE 1976 (CIELAB) systems created by the International Commission on Illumination, which provides standards for lighting, color, or colorimetry.

In the present invention, reference will thus be made to these systems to define the color not only by the dominant wavelength (tint or chromatic tonality), but also by the luminance (clarity) and chromatic purity (saturation), the color modification being associated with any modification of one or more of these three parameters leading to a difference in perception using any suitable means, such as the eye, an electronic or other measurement, or a combination of these means.

Preferably, the difference in perception will be visible to the naked eye, but this does not exclude the concomitant use of an electronic device and/or a source of natural or artificial light, substituting for the eye or allowing the eye to discern the color change in the closure system.

Strong color modifications before and after heating close to or beyond the threshold temperature are preferred. The term “strong modifications” indicates modifications which are immediately identifiable by the user, for example by the consumer, in the case of bottles sold with the thermochromic closure system of the present invention.

As indicated above, the irreversible change in color close to or above a threshold temperature is obtained by incorporating a thermochromic material into the thermoplastic matrix. This thermochromic material may be a material which is initially colorless or not colored, but inactive as regards temperature before a specific activation step. During the stages of incorporation into the plastic material and production of the closure system, the material is maintained in its inactive configuration, and is then rendered active as regards a change in temperature after the closure system has been produced.

The thermochromic pigment is selected from those which give rise to an irreversible color change.

Of the thermochromic compounds that may be used, a particularly interesting category is constituted by diacetylenic compounds. Certain diacetylenic derivatives have the ability to polymerize in the solid state, generally by a thermal effect or by exposure to high energy radiation (UV, X or gamma rays, slow electrons).

The monomer is generally colorless but absorbs strongly in the ultraviolet (UV). An intense color appears during polymerization. In general, this color is considered to be due to strong delocalization of n electrons along the polymer chain due to overlapping of the n orbitals of the carbon atoms.

During a temperature rise, fusion of the side groups of the polydiacetylene chain endows it with a degree of mobility. This causes a loss of its planar nature and thus to a reduction in the conjugation length, which considerably modifies the absorption spectrum.

Depending on the nature of the base monomer, the color change temperature of the thermochrome may be reduced or, in contrast, raised. In the same manner, the color change may be reversible or irreversible. The amide groups give rise to the formation of hydrogen bonds between adjacent chains, which has the effect of increasing the thermochromic transition temperature and of encouraging reversibility of the color change. In contrast, ester bonds produce weak intermolecular bonds, which have the effect of reducing the color change temperature. The color change, which corresponds to a reduction in order in the polymer, is thus irreversible.

As described above, and in an advantageous implementation of the present invention, the thermochromic pigment is incorporated into the molten polymer matrix destined to form the closure system. Since the fusion temperature of the polymer matrix is generally much higher than the color change temperature of the thermochrome, it is necessary for the thermochrome to be deactivated during the incorporation procedure, and then activated after the polymer matrix has cooled.

The thermochrome may be activated using any means which is known per se, and has the effect, but only after this activation step, of rendering the thermochrome heat sensitive, and more particularly of inducing a color change, as defined above, close to or beyond the threshold temperature.

After incorporating the thermochrome into the closure system, an activation step is then necessary to generate a color, that will be modified during a rise in temperature above a limiting value, thus rendering visible any tampering or any attempt at tampering.

In another feature of the invention, the activation step does not generate any color in the thermochrome, with a rise in temperature above a limiting value then causing a color to appear, providing evidence of tampering or an attempt at tampering.

As indicated above, a particularly advantageous category of thermochromic materials which may be used is the polyacetylenic monomer category, preferably diacetylenic. Certain diacetylenic monomers have, for example, been described in U.S. Pat. No. 5,731,112 and U.S. Pat. No. 4,228,126. More particularly, certain of said monomers have general formula (I):
R—C≡C—C≡C—R′ (I)
in which R and R′, which may be identical or different, independently represent a linear or branched, saturated or completely or partially unsaturated alkyl chain, optionally interrupted by and/or comprising at its end one or more cycles, heterocycles, and heteroatoms selected from oxygen, nitrogen, and sulfur, said heteroatoms, which may be bonded together, optionally forming groups or functions such as ester, amide, ether, carboxyl, hydroxyl, amine functions, etc, for example. Further, R and R′ may together form a cycle with the carbon atoms carrying them.

There is no particular limitation as regards the nature of the compounds of formula (I) that can be used in the context of the present invention. However, for the specific claimed use, the choice of thermochromic compound is guided by the fact that it must be capable of being activated, it must have a change temperature, i.e. a color change temperature, that is close to the tampering temperature, and finally it must have an irreversible color change close to or beyond the color change temperature.

The activation step in this case corresponds to polymerization of the monomers. Under the effect of heat, close to or beyond a threshold temperature, the polymerizate undergoes a conformational change leading to a change in its original color. Such compounds have been widely described, for example in U.S. Pat. No. 5,085,801. Preferred compounds having formula (I) above are those in which R and R′ are never simultaneously alkyl groups, whether they are identical or different (symmetrical or asymmetrical).

Monomers which, after activation, for example by irradiation, result in the formation of a blue colored polymer, such as the diacetylenes hereinafter termed Tc and Pc, are of particular interest.

Pc is pentacosa-10,12-diynoic acid (melting point 62-63° C.) described, for example, in J. Phys. Chem., 100 (1996), 12455-12461, available from Farchan Laboratories.

Tc is tricosa-10,12-diynoic acid (melting point 54-56° C.) described, for example, in J. Phys. Chem B, 106 (2002), 9231-9236, available from GFS chemicals.

The polymers formed from said monomers have a blue color after irradiation then turn to pink, or even red, after heating beyond the threshold temperature.

Other advantageous diacetylenic monomers are urethanes obtained by reaction of an isocyanate on a diol, such as diacetylenes hereinafter termed Ma01 and Ma02. The denominations and melting points (MP) of these two substances are respectively:

Ma01: 2,4-hexadiyn-1,6-bis(n-hexylurethane);

Ma02 is a mixture of monomer Ma01 and the 2,4-hexadiyn-1-hexyl-6-pentylurethane monomer in 90/10 molar proportions; and

the melting point (MP) of each of the two monomers is 84-85° C.

The polymers formed from said monomers turn red after irradiation and black after raising the temperature beyond the threshold temperature. It is clearly possible to use mixtures of these compounds in any proportions.

The thermochromic compound constituted by monomers is thus introduced into the thermoplastic matrix in its inactive state, preferably by producing a master mixture. After producing the closure system in which the pigment is incorporated in the crystalline state, this is irradiated, for example using UV radiation. This constitutes the activation step which results in the appearance of a color. The polymer formed is then reactive as regards temperature (i.e. raising the temperature beyond a threshold temperature causes a change in its color).

When the closure system is heated beyond the color change temperature of the thermochromic compound, the color change takes place in a few seconds, preferably in less than one second.

In the event of tampering by raising the temperature of the closure system beyond the threshold temperature, the activated thermochrome changes color irreversibly, this having the direct effect that the color of the closure system is modified or another color appears, rendering irreversibly visible any tampering or attempt at tampering. The irreversible modification or appearance of color of the closure system is retained even after cooling to ambient temperature, thus providing evidence of tampering.

This color change temperature, which must be understood to be the threshold temperature described above, must in principle correspond to the minimum temperature to which the closure system of the invention needs to be heated in order to render it sufficiently malleable to be removed and then subsequently replaced (constituting tampering), without, however, causing any damage to said closure system.

The term “sufficiently malleable” means that the closure system is sufficiently softened to allow complete removal of said closure system and repositioning thereof without substantial degradation, in particular without visible degradation, in particular without degradation of the mechanical anti-tampering system, such as the frangible bridging tabs and ring optionally included in said closure system.

This minimum temperature must, however, be sufficiently high to avoid any accidental color change of the thermochrome at ambient temperature or at storage temperatures to which the receptacle provided with said closure system may be subjected.

Thus, the thermochrome must be selected and/or adapted as a function of the nature of the thermoplastic polymer matrix and any other constituent components of the closure system, so that the color change temperature essentially corresponds to the minimum temperature at which said closure system becomes sufficiently malleable for it to be removed and repositioned without being substantially degraded.

The thermochromic pigment is advantageously selected so that the color change temperature of the thermochromic pigment and the thermochromic material constituted by the pigment and the thermoplastic is in the range 50° C. to 100° C., advantageously in the range 60° C. to 100° C. and preferably in the range 60° C. to 70° C.

The present invention may thus make use of any crystalline diacetylenic compound or mixture of a plurality of crystalline diacetylenic compounds which, once polymerized, changes color in an irreversible manner at a temperature in the range 50° C. to 100° C., advantageously in the range 60° C. to 100° C., and preferably in the range 60° C. to 70° C.

Further, and in accordance with a particular implementation of the invention, the thermochromic pigment is selected so that the color change of said pigment and of the thermochromic material constituted by the pigment and the thermoplastic, operates over a temperature range of 20° C., preferably 10° C., more preferably 1° C. or 2° C. around the color change zone.

It is also advantageous, although not altogether necessary, for the color change of the thermochromic pigment and the thermochromic material constituted by the pigment and the thermoplastic to operate in less than 30 seconds (s), and preferably in less than one second, in the temperature range of the color change. Longer periods may be envisaged, however, but could lead to total ineffectiveness of the tamper-control system of the invention.

The quantity of thermochromic pigment in the closure system is advantageously in the range 0.1% to 10% by weight, preferably in the range 0.2% to 1.5% by weight.

Depending on the intrinsic nature of the thermochromic compound in the monomeric state, in particular in the case of diacetylenics, it generally appears that the intensity of the color generated during irradiation increases with the concentration of the thermochrome in the polymer matrix.

Clearly, an increase in the intensity of the color when the intensity of irradiation increases may also be observed.

The skilled person can adapt the concentrations of the pigment and the intensity of irradiation during the activation step, depending on the intensity of the desired color in the closure system of the present invention.

However, it should be noted that below 0.1% by weight, the quantity of thermochromic pigment after activation may prove to be unsuitable for generating a sufficient color or a sufficient color change following a rise in temperature. Further, a quantity of thermochrome of more than 10% by weight in the closure system may possibly deleteriously affect the mechanical, chemical and/or physical strength of the closure system.

In the case of certain diacetylenic monomers, the color change is irreversible if a suitable pigment concentration is selected. If the pigment concentration is too high, typically of the order of a few percent, polymerization of a monomer which may not be polymerized during the color generation step continues in natural light, which results in attenuation of the color observed after heating. With high concentrations of pigment, one possibility consists in adding to the mixture constituted by the plastic material and the pigment a monomer polymerization inhibiting substance. This is constituted by a compound such as a “hindered amine light stabilizer” (HALS) or a UV absorber, preferably Tinuvin P® supplied by Ciba Geigy, which has the advantage of being licensed for contact with food and which absorbs UV radiation from natural light preventing or considerably minimizing the loss of color obtained after heating.

In a preferred implementation, the principal constituent of the closure system of the present invention is a thermoplastic matrix, while any other type of polymer matrix, into which a thermochromic pigment may be incorporated, may be used.

However, it is important to ensure that the thermoplastic or other matrix is compatible with the thermochromic pigment used. Thus, the use of matrices which are associated with exudation, or where migration of the pigment to the surface may be observed, should be avoided.

In such cases however, the thermochromic pigment may, for example, be encapsulated prior to its incorporation into the thermoplastic matrix to avoid the migration phenomena defined above. Other methods which are known to the skilled person may be used to reduce or to eliminate completely any pigment migration or exudation effect.

Such methods, including encapsulation, may also advantageously be used during production of the closure system of the invention, when the selected pigment has food compatibility problems.

Several encapsulation techniques may be employed, such as coacervation using gelatin as an encapsulating medium, interfacial polymerization or in situ polymerization.

The matrix into which the closure system defined above is incorporated is advantageously essentially constituted by a thermoplastic polymer. Any thermoplastic polymer, in particular those normally used to fabricate closure systems, such as polyethylene (PE) or polypropylene (PP), their copolymers, and mixtures of said polymers and/or copolymers, may be suitable. The thermoplastic matrix optionally contains any type of filler usually used for the application, such as an agent for re-crystallization of the thermochromic compound, a mechanical strengthener, pigment, anti-UV agent, plasticizer, etc. Examples of polymer matrices and their characteristics are given below.

TABLE 1

| | Melting point | Melt flow |
|---|---|---|
| Matrix (supplier) | MP (° C.) | index (MFI) |
| PE (Aldrich) | 109 [93-112] | 55 |
| PE Rigidex ® (BP Solvay) | 124 [111-127] | 11 |
| PE Eltex ® (BP Solvay) | 126 [112-129] | 2 |
| PE Lacqtène ® (Atofina) | 112 | 7 |
| PE Flexirène ® (Polimerl) | 128 | 22 |
| PP Moplen (Basel) | 164 [150-169] | 12 |

The closure system with tamper control comprising at least one thermochrome as defined above may also comprise one or more “mechanical” tamper-control means. The term “mechanical tamper-control means” means any means known per se that causes, after said closure system has been opened for the first time, an irreversible mechanical degradation of the closure system, providing evidence that said system has been opened. Advantageously, said mechanical degradation does not affect closure of the receptacle provided with the closure system, but simply provides evidence of a first opening.

Such a mechanical tamper-control means is, for example, constituted by a closure provided with a screw thread and connected to a ring via rupturable bridging tabs. When opening the closure for the first time, the action of unscrewing causes the bridging tabs to break, resulting in irreversible separation of most or all of the bridging tabs, thus providing evidence of opening of the closure system.

In a second aspect, the present invention provides the use of at least one thermochromic pigment for the production of a closure system as defined above, said closure system optionally further comprising one or more mechanical tamper-control means.

In a third aspect, the present invention relates to the method of preparing the closure system as defined above.

The method of the invention comprises the following steps:

a) incorporating at least one thermochromic pigment in its inactive form into the polymer matrix constituting said closure system;

b) forming the closure system; and

c) activating the thermochromic pigment.

The monomer is generally hot mixed into the thermoplastic matrix at a temperature T_{inclusion} which is higher than the melting point of the matrix. This temperature is thus dependent on the nature of the polymer matrix. By way of example, T_{inclusion} is in the range 130° C. to 250° C., preferably in the range 160° C. to 190° C. in the case of thermoplastic matrices.

After the thermochromic pigment has been incorporated into the matrix, the mixture is cooled before being used.

Depending on the nature of the thermochrome, it may prove necessary to crystallize the pigment, advantageously after forming the closure system.

When using a diacetylenic monomer type pigment, the thermochromic pigment is reactive to UV only when in its crystalline form. After producing the closure system, which is carried out at a temperature that is higher than the melting point of the thermochromic pigment, it is necessary to allow the pigment time to recrystallize within the matrix.

The re-crystallization time depends on the concentration of the pigment. The lower this concentration, the more time is required for complete re-crystallization of the pigment.

The re-crystallization time is generally in the range from a few minutes to a few days.

Further, and preferably, the thermochromic pigment(s) is (are) initially incorporated into a master mixture, said master mixture being then mixed with the base material (polymer matrix constituting the closure system).

After incorporating the pigment into the thermoplastic matrix at the temperature T_{inclusion} as indicated above, it is cooled and optionally reduced to granules to produce the closure systems.

Similarly, any master mixture into which an inactive thermochromic pigment has been incorporated may be made into granules. The advantage of granules is that they are easier to store, handle, and use.

The master mixture containing the thermochromic pigment is mixed with the base material. The mixture formed is used to produce the closure systems. Conventional implementation techniques which are known to the skilled person, such as extrusion, injection, or injection molding, may be used. In general, the operating temperature is higher than the melting point of the thermoplastic matrices. It is, for example, between 130° C. and 250° C., typically between 160° C. and 190° C. in the case of thermoplastic matrices.

In a variation, the thermochromic pigment may also be incorporated into only part of the closure system, it being manufactured using particular processes such as bi-injection molding.

FIG. 1 represents a method of incorporating the thermochromic element claimed in the invention. Starting from a specific thermochromic material, the working material is produced, followed by the colorless (or possibly colored) closure system, which may or may not be rendered colored by activation of the pigment to allow tampering to be detected by the appearance of or modification to a color of the closure system when the temperature rises above a threshold value (heating).

After producing the closure system, a pigment activation system is necessary to render it active in response to a change in temperature.

Any process of activating the pigment may be suitable, it being understood that the nature of the activation process and the parameters of the activation process may vary as a function of the nature and the quantity of the thermochromic pigment(s) incorporated into the polymer matrix. Various activation processes are known and have been described in the prior art discussed above in the present description, such as high energy photopolymerization.

In the case of using a diacetylenic monomer, the thermochromic pigment present in a crystalline form inside the thermoplastic matrix is irradiated, which causes polymerization of the monomer and generation of a color. The polymer formed is reactive to temperature.

The monomer may, for example, be activated by means of UV irradiation with a suitably selected wavelength and power.

The incident UV radiation penetrates inhomogeneously through the thickness of the thermoplastic. A UV gradient is created, which results in a polymerization gradient through the thickness of the thermoplastic. Thus, it may be necessary to irradiate at different locations around the thermoplastic using one or more sources, simultaneously or successively.

There are no restrictions on the nature of the pigment, as long as it has an inactive form during incorporation into the polymer matrix, so long as it can be activated to render it sensitive to heat (temperature rise over a threshold value), and so long as it produces a color after activation and exposure to heat, which effect differs from its original color after activation. As an example, before activation, the thermochrome may be either colorless or already colored, and it may be colorless or have a color identical or different to the color preceding its activation.

A further possibility thus consists in using a colored thermochromic compound which is initially inactive as regards temperature. As illustrated in FIG. 2, from this thermochrome, the working material and then the colored closure system are produced in succession, which working material is rendered active as regards temperature by activating the pigment, which activation may or may not be accompanied by a color change. When raising the temperature beyond the threshold temperature, tampering is shown up by an irreversible modification to the color of the closure system during heating.

FIG. 3 represents a variation in the method of the invention, in which the thermochrome pigment is incorporated into the working material via a master mixture.

In the particular case of thermochromic diacetylenic type pigments, the various steps of the method of incorporating the thermochromic pigment into the closure system are shown in FIG. 4.

As in FIG. 3, the thermochromic pigment is incorporated initially into the thermoplastic matrix, which constitutes step 1, termed “master mixture production”. During step 2, the mixture of the master mixture with the base material is produced just before fabrication of the closure system which constitutes step 3.

The proportion of the master mixture in the base material can vary and is typically less than 20%. However, this proportion may vary depending on the nature of the polymer matrix and the thermochromic pigment(s). The most suitable proportion is readily accessible to the skilled person, a specialist in the transformation of plastic materials.

It should be noted that the concentration of pigment in the master mixture is adjusted to produce the desired concentration in the final mixture constituted by the master mixture and the base material.

Because of the thermochromic closure system of the present invention, it is henceforth possible to easily establish (generally by observation with the naked eye) whether tampering of said closure system has occurred by exposure to a temperature close to or above the color change temperature of the thermochromic pigment incorporated into the closure system.

Thus, in another aspect, the present invention also provides a method of checking for tampering by exposing at least a portion of a closure system as defined above to a temperature close to or above the color change temperature of the thermochromic pigment, the method being characterized in that the color of a reference closure system which has not been exposed to a temperature close to or above the color change temperature of the thermochromic pigment is compared with a closure system that might have been exposed to a temperature close to or above said color change temperature of the thermochromic pigment incorporated into said closure system.

As indicated above, it is preferable that the comparison of the colors of the reference and the closure system that might have been heated should be visible in natural light and to the naked eye. However, it may be possible to use artificial light and/or a measuring apparatus which can discern the change in the color of the thermochromic pigment that takes place close to or beyond the color change temperature of said pigment. In some cases, it may be advantageous for the color change not to be visible directly and easily by the user.

The invention also provides any packaging material constituted wholly or in part by a thermoplastic material which might be subjected to a tampering attempt by raising the temperature, such as the necks of card packaging with a thermoplastic closure system or thermoplastic closures with a metal cap which may be detached by raising the temperature.

Finally, the invention provides containers and other receptacles provided with a closure system as defined in the present invention.

The closure system comprising a thermochromic tamper-control means in accordance with the invention is advantageously used to close bricks, bottles, and other receptacles intended to receive liquids, such as fruit juice, sodas, mineral water, etc.

In a preferred embodiment, the thermochromic closure system further comprises a mechanical tamper-control means as defined above, tamper-control means of the ring and bridging tabs type being particularly preferred.

The closure system of the present invention is of particular use in the case of bottles, in particular mineral water bottles. In this case, the bottle is a bottle of mineral water with a screw cap type closure system with a frangible ring and bridging tabs into which at least one thermochromic pigment is incorporated to form a thermochromic closure system in accordance with the present invention.

### DESCRIPTION OF DRAWINGS AND FIGURES

FIGS. 1, 2 and 3 represent the method of the invention, consisting in incorporating an initially inactive thermochromic pigment into the closure system, and then rendering it active.

FIG. 4 represents the method of the invention in the case of a diacetylenic monomer.

FIG. 5 illustrates the behavior with temperature of a polymer film containing the thermochromic pigment Pc produced using the method of Example 1.

FIG. 6 illustrates the temperature stability (50° C.) of a polymer film containing the thermochromic pigment Pc produced using the method of Example 1.

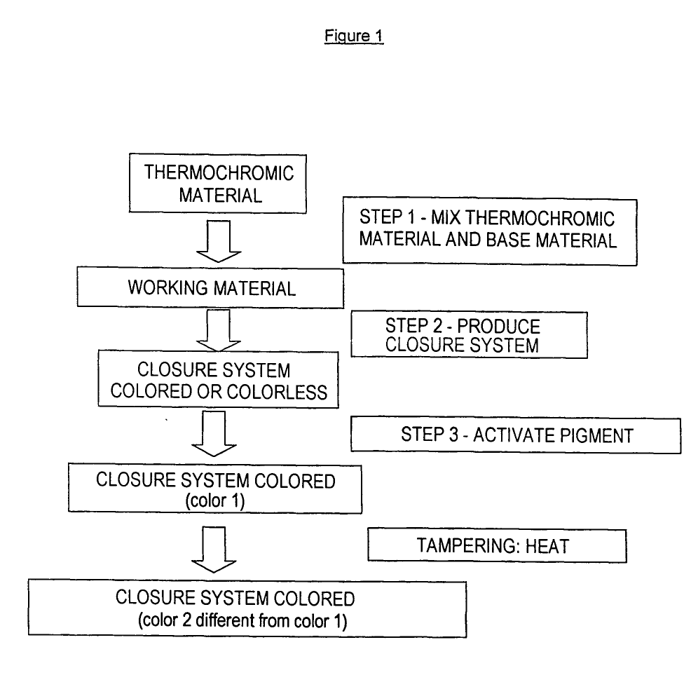

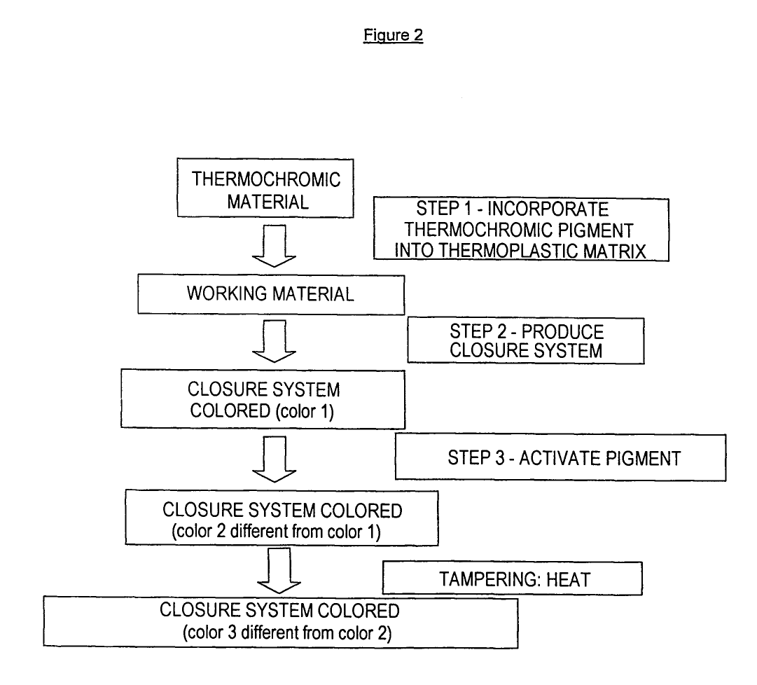

The following examples illustrate the invention by presenting several implementations thereof. The examples must in no case be understood to constitute any limitation on the ambit of the invention, the scope of which is defined in the accompanying claims.

### EXAMPLES

### Example 1

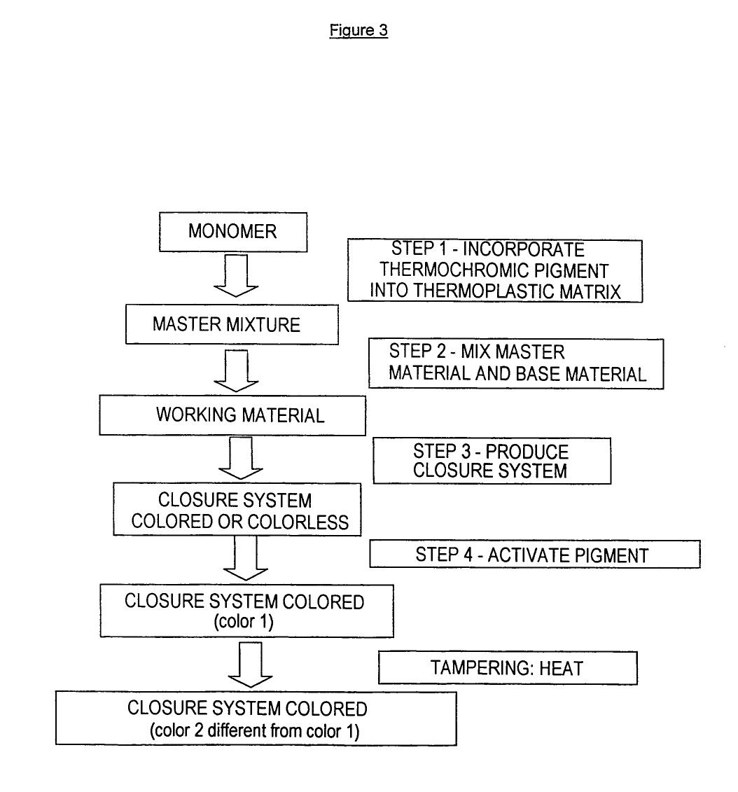

Monomer Pc was used in this example. It was initially tested alone, then the various steps concerning production of the thermochromic closures in accordance with the invention described in FIG. 3 were carried out.

Study of Temperature Behavior of Pigment Pc

Before Irradiation

The melting point of the pigments was determined by differential scanning calorimetry (DSC) after several temperature cycles.

Regarding pigment Pc, the DSC results are as follows:

| | | |
|---|---|---|
| 1^{st} temperature cycle | 25-100° C. | MP = 60° C. |
| 2^{nd} temperature cycle | 25-200° C. | MP = 63° C. |
| 3^{rd} temperature cycle | 25-250° C. | MP = 62° C. |
| 4^{th} temperature cycle | 25-300° C. | MP = 62° C. |

We could thus conclude from these studies that this thermochromic compound had good temperature stability (before irradiation).

After Irradiation

Since the thermoplastic films into which the thermochromic pigments obtained were incorporated were diffusive, both because of their thickness and the crystalline nature of the thermoplastic, it was not possible to characterize their color change with temperature in a very quantitative manner. For this reason, the thermochromic pigments were incorporated into a transparent poly(vinyl acetate) (“PVAc” below) type film.

20 milligrams (mg) of monomer Pc was dissolved in a 25% solution of PVAc polymer in an (80/20) ethanol/water mixture. The mixture was deposited in a thin film. After evaporating off the solvent, the pigment crystallized. The film was then irradiated for 5 s at 254 nanometers (nm). A blue color appeared.

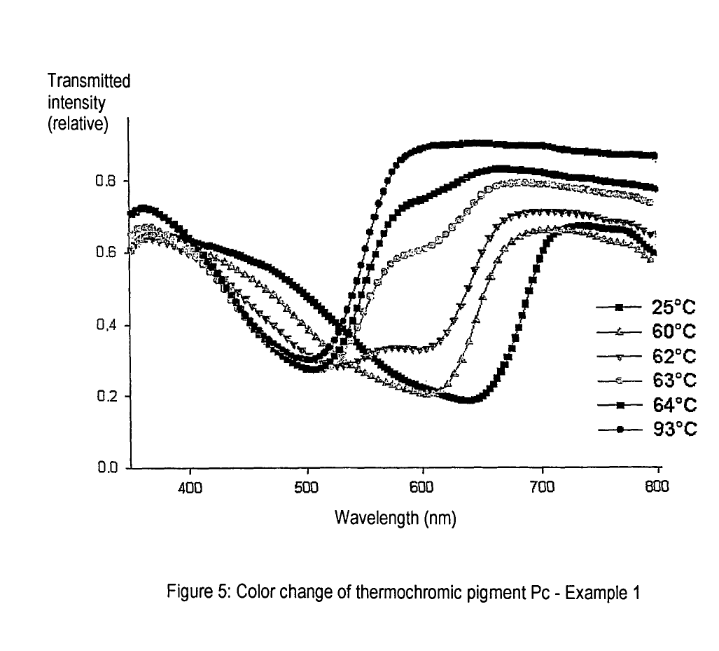

FIG. 5 illustrates the color change of the initially blue polymer film which turned pink-orangeish when the threshold temperature was exceeded.

The time-temperature stability of the thermochromic pigments was studied to ensure that no color change occurred below the color change temperature even for very long exposure times. The thermochromic PVAc films were heated for several days at a temperature of 50° C. and 55° C. The transmission spectra of the films were regularly recorded to characterize the color of the film.

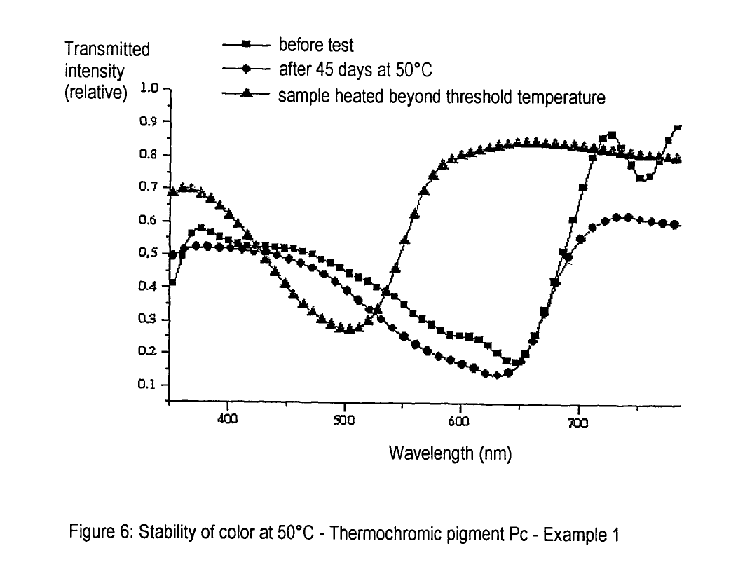

FIG. 6 shows the spectra obtained for PVAc films heated to 50° C. before the test and after 45 days; the color changes are almost identical, which means the stability of the thermochromic pigment at 50° C. was excellent. Similar results were obtained at 55° C.

Fabrication of Closure System (Closures)

Pigment Pc was used to produce the thermochromic closures of the invention.

Step a): Fabrication of Master Mixture

A final thermochromic compound content of 1% was desired. The relative proportion of master mixture to base material was 10/90.

10 grams (g) of master mixture was prepared by incorporating 1 g of thermochrome Pc into 9 g of Rigidex® PE matrix. The two components were mixed then deposited as a thin film and cooled to ambient temperature.

The master mixture was then reduced to small granules and was carefully stored away from the light.

Step b): Production of Closures

The master matrix was used to fabricate closures. It was mixed with the PE Rigidex® base material in a proportion of 10/90. The closures were produced using a Billon machine; the transformation temperature was 190° C.

After producing the closures and leaving for several days, they were irradiated at 254 nm for 5 s, 30 s and 1 minute (min) to generate colors of different intensities.

Tamper Test

After filling bottles and closing with the closures prepared above, they were immersed in water at 65° C. or at a higher temperature, causing the expected irreversible instantaneous color change.

### Example 2

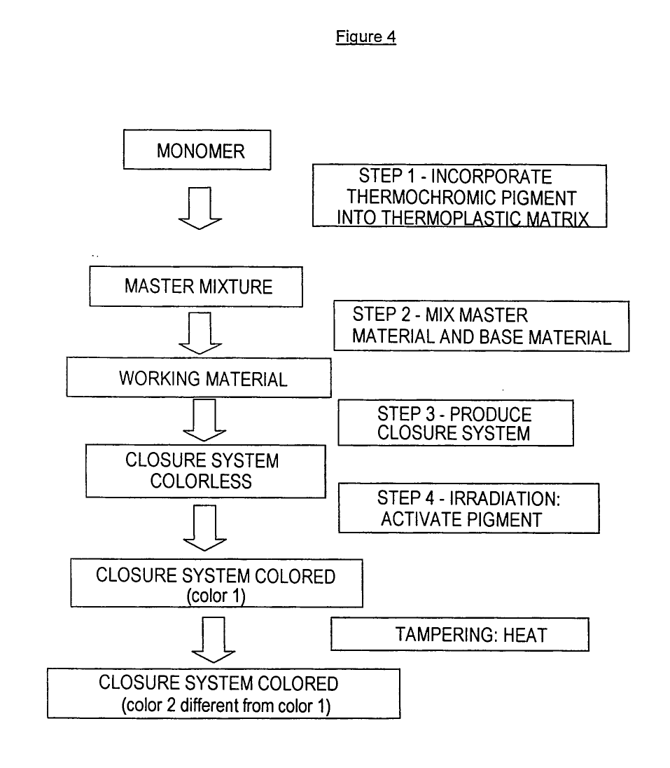

Monomer Pc was used in this example. All of the steps of the method of FIG. 4 were carried out as described in Example 1, with the exception of step 1, in which the concentration of the thermochromic pigment was modified.

Pigment Pc was introduced into the PE Rigidex® thermoplastic matrix in concentrations of 0.2%, 0.5%, 1% and 2%. The higher the concentration of pigment, the shorter the time needed for irradiation to generate a blue tint.

### Example 3

Monomer Pc was used in this example. All of the steps of the method of FIG. 4 were carried out as described in Example 1, with the exception of step 4 in which the irradiation period was modified.

Increasing the irradiation period from 10 s to 1 min resulted in an intensification of the blue tint which changed from a pale blue to a very dark midnight blue.

### Example 4

Monomer Pc was used in this example. All of the steps of the method of FIG. 4 were carried out as described in Example 1, with the exception of the pigment re-crystallization time.

Irradiation immediately after producing the closure did not cause coloration.

### Example 5

Monomer Pc was used in this example. All of the steps of the method of FIG. 4 were carried out as described in Example 1.

On irradiating for 10 s at 254 nm, an intense blue color appeared. After heating to 65° C., the polymer matrix turned orangey-pink. After 4 weeks, a slight reduction in the pink color was observed.

### Example 6

Monomer Pc was used in this example. All of the steps of the method of FIG. 4 were carried out as described in Example 1, with the exception of step 1 during which a Tinuvin P® (Ciba Geigy) UV absorber was added to the mixture of the base material and the thermochrome in an amount of 25% by weight with respect to the thermochromic pigment.

The closures produced were irradiated for 30 s at 254 nm; a blue color appeared. After heating to 65° C., the polymer turned orangey-pink. After 4 weeks, less color had been lost than that observed for the closure with no UV absorber.

### Example 7

Monomer Ma01 was used in this example. It was initially tested alone, then the various steps described in FIG. 4 were carried out.

Study of Temperature Behavior of Pigment Ma01

Before Irradiation

The melting point of the pigment was determined by DSC after several temperature cycles.

Regarding pigment Ma01, the results of the DSC analyses were as follows:

| | | |
|---|---|---|
| 1^{st} temperature cycle | 25-200° C. | MP = 86° C. |
| 2^{nd} temperature cycle | 25-250° C. | MP = disappearance |
| | | of peak |

Thus, pigment Ma01 was damaged at high temperature.

After Irradiation

200 mg of a 15% solution of Ma01 in dichloromethane was mixed with 100 mg of a 30% by weight solution of Hostaflex® CM131 resin (from UCB) in acetone. After depositing the thin layer and evaporating off the solvent, the pigment crystallized. Polymerizing the film at 254 nm for 5 s colored the film red.

When the film was heated to 80° C., it instantaneously turned black.

Fabrication of Closure System (Closures)

Pigment Ma01 was used to produce thermochromic closures in accordance with the invention.

Step a): Fabrication of Master Mixture

A final thermochromic compound content of 3% was desired. The relative proportion of master mixture to base material proportion was 20/80.

10 g of master mixture was thus prepared by incorporating 1.5 g of thermochrome Ma01 into 8.5 g of Rigidex® matrix. The two components were mixed then the mixture obtained was deposited as a thin film and cooled to ambient temperature.

The master mixture was then reduced to small granules and was carefully stored away from the light.

Step b): Production of Closures

The master matrix was used to fabricate closures. It was mixed with the Rigidex® PE matrix in a proportion of 20/80. The closures were produced using a Billion machine; the transformation temperature was 190° C.

After producing the closures and leaving for several days, they were irradiated at 254 nm for 5 min, which resulted in the appearance of a very intense red color.

Tamper Test

After filling the bottles and closing with the closures prepared above, they were immersed in water at 85° C. or at a higher temperature, causing the expected irreversible instantaneous color change. The closure turned nearly black.

### Example 8

Monomer Ma02 was used in this example. It was initially tested alone, then the various steps described in FIG. 4 were carried out.

Study of Temperature Behavior of Pigment Ma02

Before Irradiation

The melting point of the pigment was determined by DSC after several temperature cycles.

Regarding pigment Ma02, the results of the DSC analyses were as follows:

| | | |
|---|---|---|
| 1^{st} temperature cycle | 25-200° C. | MP = 84° C. |
| 2^{nd} temperature cycle | 25-250° C. | MP = 80° C. |

Pigment Ma02 had better temperature resistance than pigment Ma01.

After Irradiation

200 mg of a 15% solution of Ma02 in dichloromethane was mixed with 100 mg of a 30% by weight solution of Hostaflex® CM131 resin in acetone. After depositing the thin layer and evaporating off the solvent, the pigment crystallized. Polymerizing the film at 254 nm for 5 s colored the film red.

When the film was heated to 80° C., it turned black instantly.

Fabrication of Closure System (Closures)

Pigment Ma02 was used to produce the thermochromic closures of the invention.

Step a): Fabrication of Master Mixture

A final thermochromic compound content of 3% was desired. The relative proportion of master mixture to base material was 20/80.

10 g of master mixture was prepared by incorporating 1.5 g of thermochrome Ma02 into 8.5 g of Rigidex® matrix. The two components were mixed, then the mixture obtained was deposited as a thin film and cooled to ambient temperature.

The master mixture was then reduced to small granules and was carefully stored away from the light.

Step b): Production of Closures

The master matrix was used to fabricate closures. It was mixed with the PE Rigidex® base material in a proportion of 20/80. The closures were produced using a Billion machine; the transformation temperature was 190° C.

After producing the closures and leaving for several days, they were irradiated at 254 nm for 5 min, which resulted in the appearance of a very intense red color.

Tamper Test

After filling the bottles and closing with the closures prepared above, they were immersed in water at 85° C., causing the expected irreversible instantaneous color change. The closure turned nearly black.

### Example 9

In this example, all of the steps of the method of FIG. 4 were carried out as described in Example 1, with the exception of the nature of the thermochromic pigment used, which was pigment Tc.

After producing the closure, it was irradiated with UV at 254 nm for 10 s. An intense blue color appeared. When the closure was heated to 55° C., it irreversibly changed color from blue to pink.

### Example 10

Encapsulation of Thermochromic Pigment

Description of process of encapsulating pigment Pc by interfacial polymerization.

Ingredients: 17 g of 10% aqueous PVAc solution;

1 g of Pc;

0.5 g of Desmodur N3200®

After dissolving pigment Pc at 90° C. in the aqueous solution, the isocyanate was added. The mixture was emulsified at 20000 revolutions per minute (rpm) then transferred into a beaker and magnetic stirring was continued at 1000 rpm at the same temperature. 4 g of a 2% Dabco solution and 3.5 g of a 2% ethylenediamine solution were then added. The reaction was continued for 1 hour (h). Capsules were recovered by filtering then irradiation, leading to the appearance of a blue color.

The encapsulated and not activated thermochromic pigment could then, for example, be incorporated into a master mixture as described in Example 1 (steps a) and b)) to prepare thermochromic closures in accordance with the invention.

1. A closure system with thermochromic tamper-control means, said closure system comprising a thermoplastic polymer matrix into which at least one thermochromic pigment is incorporated the color of which is capable of being irreversibly modified after exposure of at least a part of said closure system to a temperature close to or beyond a threshold temperature, the system being characterized in that said threshold temperature corresponds to the minimum temperature to which the closure system of the invention must be heated to render it sufficiently malleable to be removed then subsequently replaced without, however, causing any damage to said closure system.

2. A closure system according to claim 1, characterized in that the thermochromic pigment is inactive as regards temperature during all of the stages of fabricating the closure system, and is then rendered active by an activation process after producing the closure system.

3. A closure system according to claim 1, characterized in that the thermochromic compound is selected from diacetylenic type compounds.

4. A closure system according to claim 1, characterized in that before activation, the thermochromic pigment is a compound or a mixture of diacetylenic compounds with general formula (I):
R—C≡C—C≡C—R′ (I)
in which R and R′, which may be identical or different, independently represent a linear or branched, saturated or completely or partially unsaturated alkyl chain, optionally interrupted by and/or comprising one or more cycles at its end, heterocycles and heteroatoms selected from oxygen, nitrogen, and sulfur, said heteroatoms, which may be bonded together, optionally forming groups or functions such as ester, amide, ether, carboxyl, hydroxyl, amine, etc, for example, R and R′ possibly together forming a cycle with the carbon atoms carrying them.

5. A closure system according to claim 4, characterized in that before activation, the thermochromic pigment is a compound or a mixture of diacetylenic compounds with formula (I) in which R and R′ are never simultaneously alkyl groups.

6. A closure system according to claim 5, characterized in that before activation, the thermochromic pigment is selected from pentacosa-10,12-diynoic acid, tricosa-10,12-diynoic acid, 2,4-hexadiyn-1,6-bis(n-hexylurethane), its mixture with 2,4-hexadiyn-1-hexyl-6-pentylurethane in a 90/10 molar proportion, and mixtures of said compounds.

7. A closure system according to claim 1, in which the matrix further comprises a polymerization inhibitor (UV absorber, HALS (hindered amine light stabilizer)).

8. A closure system according to claim 1, in which the quantity of thermochromic pigment in the closure system is advantageously in the range 0.1% to 10% by weight, and preferably in the range 0.2% to 1.5% by weight.

9. A closure system according to claim 1, characterized in that the thermochromic pigment is encapsulated before being incorporated into the matrix.

10. A closure system according to claim 1, characterized in that the thermoplastic matrix is selected from polyethylene, polypropylene, their copolymers, and mixtures of said polymers and/or copolymers.

11. A closure system according to claim 1, characterized in that only part of the closure system contains the thermochromic pigment.

12. A closure system according to claim 1, characterized in that it can irreversibly change color at a temperature in the range 50° C. to 100° C., advantageously in the range 60° C. to 100° C., preferably in the range 60° C. to 70° C.

13. A closure system according to claim 12, characterized in that the color change occurs a temperature range of 20° C., preferably 10° C., more preferably 1° C. or 2° C. about the color change zone.

14. A closure system according to claim 1, characterized in that the color change occurs in less than 30 s, preferably in less than one second, in the color change temperature range.

15. A closure system according to claim 1, characterized in that it further comprises one or more mechanical tamper-control means.

16. A closure system according to claim 15, characterized in that the mechanical tamper-control means is a closure provided with a screw thread and connected to a ring via frangible bridging tabs.

17. The use of at least one thermochromic pigment for the production of a closure system as defined in claim 1.

18. A use according to claim 17, characterized in that the closure system further comprises a mechanical tamper-control means.

19. A method of preparing a closure system as defined in claim 1, characterized in that it comprises the steps of:
a) incorporating at least one thermochromic pigment in its inactive form into the polymer matrix of said closure system;
b) forming the closure system; and
c) activating the thermochromic pigment.

20. A method according to claim 19, further comprising a step of crystallizing the pigment after forming the closure system.

21. A method according to claim 19, in which the thermochromic pigment(s) is/are incorporated into the polymer matrix by means of a master mixture which is then mixed with the polymer matrix to produce the closure system.

22. A method according to claim 19, in which the forming step employs techniques selected from extrusion, injection and injection molding.

23. A method according to claim 22, in which the closure system is formed by a bi-injection molding technique.

24. A method according to claim 19, in which the activation step is a high energy photopolymerization step.

25. A method according to claim 19, in which the activation step is a UV irradiation step.

26. A method of checking for tampering by exposing at least a part of a closure system according to claim 1, to a temperature close to or above a color change temperature for the thermochromic pigment, characterized in that the color of a reference closure system which has not been exposed to a temperature close to or above the color change temperature of the thermochromic pigment is compared with a closure system which may have been exposed to a temperature close to or above said color change temperature of the thermochromic pigment incorporated into said closure system.

27. A container provided with a closure system according to claim 1.

28. A container according to claim 27, which is a bottle the closure system of which is of the screw closure type with a ring and frangible bridging tabs.

29. A container according to claim 27, which is a mineral water bottle.
